(19) United States
(12) Patent Application Publication
(10) Pub. No.: US 2014/0167343 A1
(43) Pub. Date: Jun. 19, 2014

(54) SYSTEM FOR POSITIONING A WORKPIECE IN A DESIRED POSITION

(71) Applicant: HON HAI PRECISION INDUSTRY CO., LTD., New Taipei (TW)

(72) Inventor: LI-CHIN LU, New Taipei (TW)

(73) Assignee: HON HAI PRECISION INDUSTRY CO., LTD., New Taipei (TW)

(21) Appl. No.: 14/101,351

(22) Filed: Dec. 10, 2013

(30) Foreign Application Priority Data
Dec. 13, 2012 (CN) 201210537099X

(51) Int. Cl. B23Q 1/64

(52) U.S. Cl. CPC B23Q 1/64
USPC 269/60; 269/58

(57) ABSTRACT

A positioning system for positioning a workpiece in a desired position is provided. The system includes a first driving device and a second driving device. The first driving device and the second driving device are used to drive the workpiece to move. The system further includes a third driving device and a fourth driving device for driving a first block and a second block to move. The moving direction and moving distance of the workpiece is determined according to a difference between a standard value and a distance that the first block and the second block have travelled.

### BACKGROUND

1. Technical Field

The present disclosure relates to a positioning system for positioning a workpiece in a desired position.

2. Description of Related Art

During assembling an electronic device, the center of a display and the center of a housing need to be coincided with each other. Although some devices and systems have been proposed for such purpose, it is still useful to provide a new positioning system for positioning a workpiece in a desired position, such that the center of the workpiece can coincide with a standard center.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is an assembled view of a positioning system of an example embodiment and a workpiece.

FIG. 2 is similar to FIG. 1, but showing that the workpiece is separated from the positioning system.

FIG. 3 is a schematic view showing various positions of a first block and a second block when the first block and the second block contact the workpiece of FIG. 1 and a standard block.

### DETAILED DESCRIPTION

Embodiments of the present disclosure will be described with reference to the accompanying drawings.

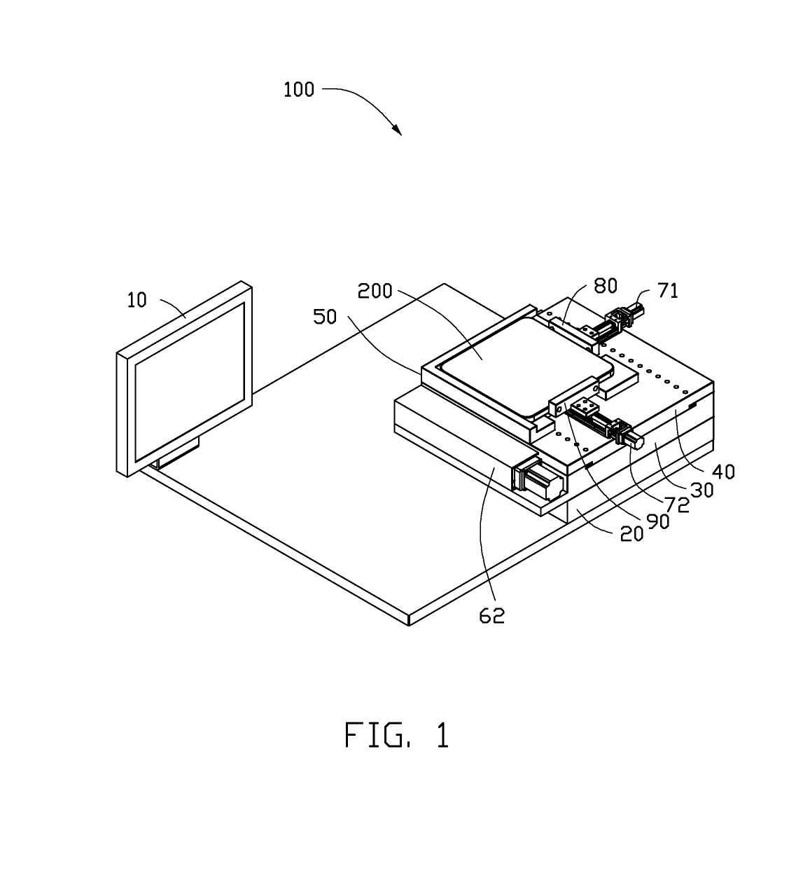

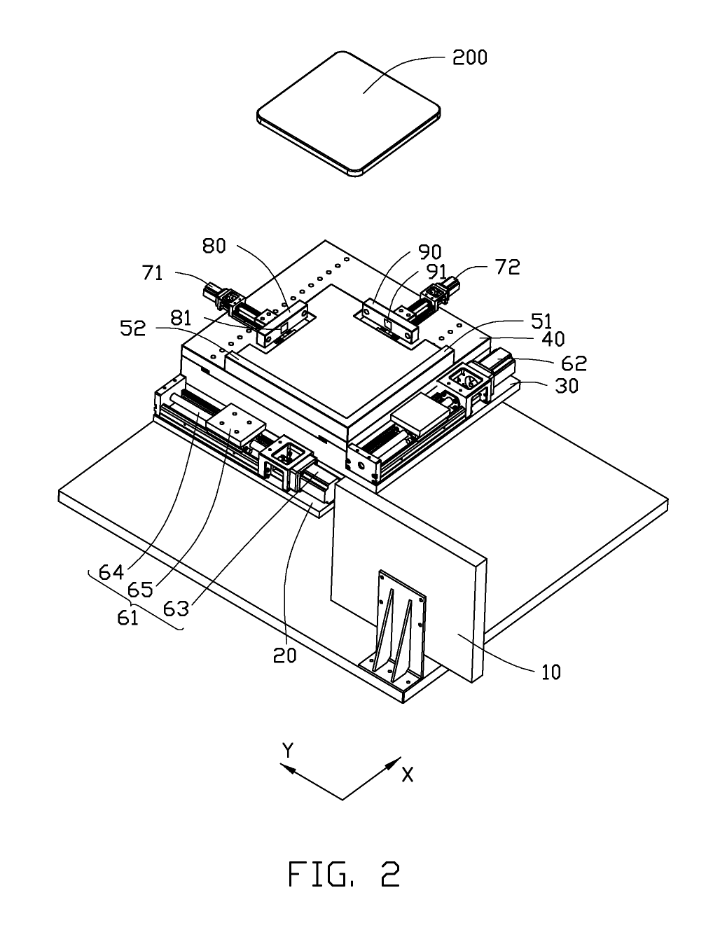

Referring to FIGS. 1 and 2, a positioning system 100 for positioning a workpiece 200 in a desired position is provided. The positioning system 100 includes a computer 10, a first platform 20, a second platform 30, a third platform 40, and a positioning member 50. The computer 10 and the first platform 20 are secured to a working table. The second platform 30 is stacked on the first platform 20, the third platform 40 is stacked on the second platform 30, and the positioning member 50 is stacked on the third platform 40. The positioning member 50 is used to position the workpiece 200. In the embodiment, the workpiece 200 is rectangular and the positioning member 50 includes two walls 51 and 52 that are perpendicular to each other for contacting two sides of the workpiece 200.

In the embodiment, the positioning system 100 further includes a first driving device 61, a second driving device 62, a third driving device 71, a fourth driving device 72, a first block 80, and a second block 90. The first driving device 61 is secured to the first platform 20, and is used to drive the second platform 30 to move with respect to the first platform 20 along a first direction as indicated by the Y axis of FIG. 2. The first driving device 61 and the second driving device 62 have the same structure, and both include a motor 63, a guide screw 64, and a sliding block 65. The motor 63 is electrically connected to the computer 10. The motor 63 is secured to the first platform 20 and used to drive the guide screw 64 to rotate. The sliding block 65 engages with the guide screw 64 and moves along the guide screw 64 when the guide screw 64 rotates. The second platform 30 is secured to the sliding block 65.

The second driving device 62 is secured to the second platform 30, and is used to drive the third platform 40 to move with respect to the second platform 30 along a second direction as indicated by the X axis of FIG. 2. In the embodiment, the first direction and the second direction are perpendicular to each other.

The third driving device 71 and the fourth driving device 72 are secured to the third platform 40, and used to respectively drive the first block 80 and the second block 90 to move. The first block 80 moves in a direction as indicated by the Y axis of FIG. 2, and the second block 90 moves in a direction as indicated by the X axis of FIG. 2. In the embodiment, the third driving device 71 and the fourth driving device 72 have the same structure as the first driving device 61. That is, the third driving device 71 and the fourth driving device 72 both include a motor, a guide screw, and a sliding block that are arranged as the motor 63, the guide screw 64 and the sliding block 65. The first block 80 and the second block 90 are secured to the sliding blocks of the third driving device 71 and the fourth driving device 72.

The positioning system 100 further includes a first pressure sensor 81 and a second pressure sensor 91. The first pressure sensor 81 is secured to a surface of the first block 80 that faces the wall 51 of the positioning member 50, and the second pressure sensor 91 is secured to a surface of the second block 90 that faces the wall 52 of the positioning member 50. The first pressure sensor 81 is used to detect the pressure between the first block 80 and the workpiece 200, and the second pressure sensor 91 is used to detect the pressure between the second block 90 and the workpiece 200. The first pressure sensor 81 and the second pressure sensor 91 are electrically connected to the computer 10.

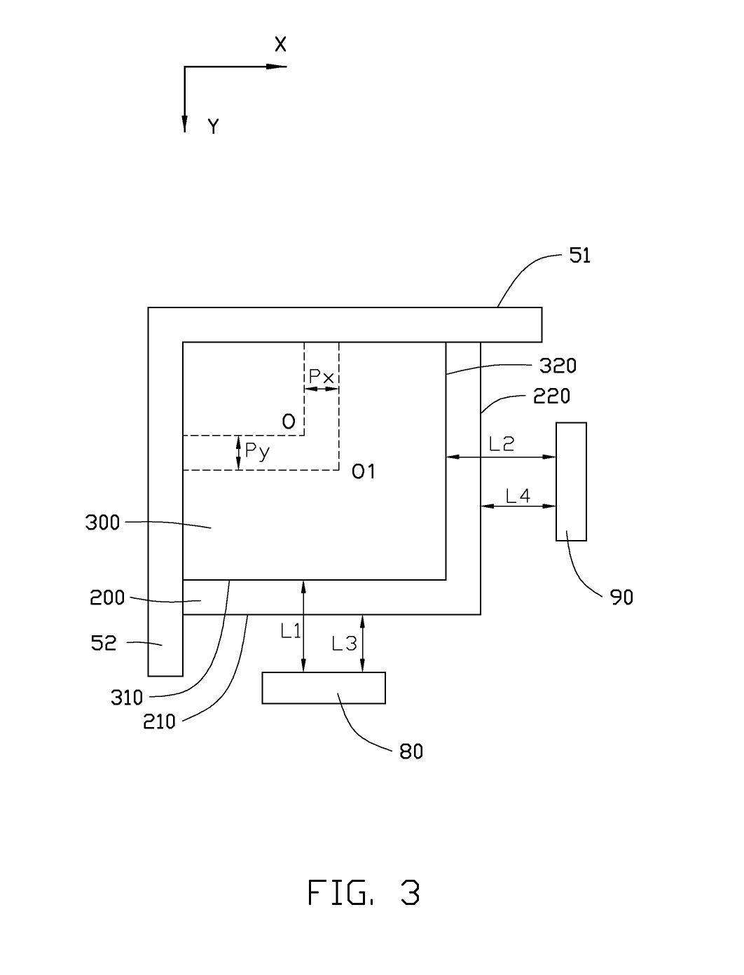

Referring to FIG. 3, in use, a standard block 300 is first placed on the positioning member 50, with its two sides contacting the walls 51 and 52. The computer 10 then controls the third driving device 71 and the fourth driving device 72 to drive the first block 80 and the second block 90 to move toward the standard block 300. When the first block 80 and the second block 90 contact the standard block 300, the computer 10 starts to monitor the pressure between the first block 80 and the standard block 300, and the pressure between the second block 90 and the standard block 300. When the pressure between the first block 80 and the standard block 300 reaches to a preset value, the computer 10 determines a first standard distance L1 that the first block 80 has traveled, and then controls the third driving device 71 to drive the first block 80 to move back to its original position. Similarly, when the pressure between the second block 90 and the standard block 300 reaches to a preset value, the computer 10 determines a second standard distance L2 that the second block 90 has traveled, and then controls the third driving device 71 to drive the second block 80 to move back to its original position.

The standard block 300 is then removed from the positioning member 50, and the workpiece 200 is placed on the positioning member 50, with its two sides contacting the walls 51 and 52. The computer 10 then controls the third driving device 71 and the fourth driving device 72 to drive the first block 80 and the second block 90 to move toward the workpiece 200. When the first block 80 and the second block 90 contact the workpiece 200, the computer 10 starts to monitor the pressure between the first block 80 and the workpiece 200, and the pressure between the second block 90 and the workpiece 200. When the pressure between the first block 80 and the workpiece 200 reaches to a preset value, the computer 10 determines a third distance L3 that the first block 80 has traveled, and then controls the third driving device 71 to drive the first block 80 to move back to its original position. Similarly, when the pressure between the second block 90 and the workpiece 200 reaches to a preset value, the computer 10 determines a fourth distance L4 that the second block 90 has traveled, and then controls the third driving device 71 to drive the second block 80 to move back to its original position.

The computer 10 then determines an X component Px of the difference between a standard center O of the standard block 300 and a center O of the workpiece 200, and a Y component Py of the difference between a standard center O of the standard block 300 and a center O of the workpiece 200. As shown in FIG. 3, the X component Px equals to a half of the difference between the length of the side 210 of the workpiece 200 and the length of the side 310 of the standard block 300. Similarly, the Y component Py equals to a half of the difference between the length of the side 220 of the workpiece 200 and the length of the side 320 of the standard block 300.

The difference between the length of the side 210 of the workpiece 200 and the length of the side 310 of the standard block 300 equals to difference between the second distance L2 and the fourth distance L4. The difference between the length of the side 220 of the workpiece 200 and the length of the side 320 of the standard block 300 equals to the difference between the first distance L1 and the third distance L3. That is, the X component Px equals to a half of the difference between the second distance L2 and the fourth distance L4, and the Y component Py equals to a half of the difference between first distance L1 and the third distance L3.

The computer 10 then controls the first driving device 61 to drive the second platform 30 to move. The moving distance of the second platform 30 equals to the absolute value of the Y component Py. The second platform 30 moves along the Y axis of FIG. 2 in a negative direction if the Y component Py is a positive value, otherwise, the second platform 30 moves along the Y axis of FIG. 2 in a positive direction. Similarly, the computer then controls the second driving device 62 to drive the third platform 40 to move. The moving distance of the third platform 40 equals to the absolute value of the X component Px. The third platform 40 moves along the X axis of FIG. 2 in a negative direction if the X component Px is a positive value, otherwise, the third platform 40 moves along the X axis of FIG. 2 in a positive direction After the movement of the second platform 30 and the third platform 40, the center O1 of the workpiece 200 coincides with the stand center O of the stand block 300. The workpiece 200 is then located in a desired position.

While various embodiments have been described and illustrated, the disclosure is not to be construed as being limited thereto. Various modifications can be made to the embodiments by those skilled in the art without departing from the true spirit and scope of the present disclosure.

What is claimed is:

1. A positioning system for positioning a workpiece, the positioning system comprising:
a computer;
a first platform;
a second platform arranged on the first platform;
a third platform arranged on the second platform;
a positioning member configured to position the workpiece, the positioning member being arranged on the third platform;
a first driving device secured to the first platform and configured to drive the second platform to move along a first direction;
a second driving device secured to the second platform and configured to drive the third platform to move along a second direction;
a first block comprising a first pressure sensor, the first pressure sensor being configured to detect a first pressure between the first block and the workpiece;
a third driving device secured to the third platform and configured to drive the first block to move along the first direction;
a second block comprising a second pressure sensor, the second pressure sensor being configured to detect a second pressure between the second block and the workpiece;
a fourth driving device secured to the third platform and configured to drive the first block to move along the second direction;
wherein when the first block and the second block comes into contact with the workpiece, the computer is configured to monitor the first pressure and the second pressure, and determines a first distance that the first block has traveled when the first pressure reaches to a first value, and a second distance that second block has traveled when the second pressure reaches to a second value, the computer is configured to control the first driving device and the second driving device to respectively drive the second platform and the third platform to move;
wherein a moving direction and a moving distance of the second platform is determined according to a difference between the first distance and a first standard value, and a moving direction and a moving distance of the third platform is determined according to a difference between the second distance and a second standard value.

2. The positioning system according to claim 1, wherein the first driving device comprises a motor, a guide screw, and a sliding block, the motor is configured to drive the guide screw to rotate, the sliding block engages with the guide screw and moves along the guide screw when the guide screw rotates, the second platform is secured to the sliding block.

3. The positioning system according to claim 1, wherein the positioning member comprises a first wall and a second wall perpendicular to each other, and the first wall and second wall are configured to contact two sides of the workpiece.

4. The positioning system according to claim 1, wherein the first direction and the second direction are perpendicular to each other.
